(19) United States
(12) Patent Application Publication
(10) Pub. No.: US 2017/0057277 A1
(43) Pub. Date: Mar. 2, 2017

(54) Decorative Ornament

(71) Applicant: James Henry Baer, Brooklyn, NY (US)

(72) Inventor: James Henry Baer, Brooklyn, NY (US)

(21) Appl. No.: 14/836,208

(22) Filed: Aug. 26, 2015

(51) Int. Cl. B44C 5/04; A47G 33/08; A47G 23/03

(52) U.S. Cl. CPC B44C 5/0446; A47G 23/03; A47G 33/08

(57) ABSTRACT

The present invention relates to decorative ornaments made out of beverage coasters. The ornaments are formed by engaging a plurality of beverage coasters with a center disc. In order to be compatible, specialized beverage coasters are provided wherein the coasters include a score line to facilitate folding and a central rectangular cutout to facilitate engagement with the center disc.

### FIELD OF THE INVENTION

The present invention relates to devices and methods for making beverage coasters into decorative ornaments.

### BACKGROUND OF THE INVENTION

Beverage coasters also known as drink coasters, coasters and beermats are items on which beverages are placed in order to protect the surface of a table or any other surface on which a beverage might be placed. Restaurants, bars and other beverage serving establishments often will have beverage coasters spread about on tables, the surfaces of bars, and other locations where beverages are placed. In addition to protecting the surfaces on which beverages are placed, beverage coasters also serve to absorb condensation dripping along the outside of the beverage vessel. Beverage coasters, and in particular beermats are often branded with trademarks, and other advertising messages. Beverage coasters are often made from high grammage paperboard, but may also be made from multiple layers of thinner paper, such as tissue paper. Important considerations in the selection of materials for the construction of coasters are water absorbency, wet rub and printability characteristics.

Beermats are often printed with a customized image and/or message. These images and messages often advertise a brand of beer or other alcoholic beverage, although they can be used to promote any product or service by use of an appropriate selection of content placed on the beermat.

The design and creation of novel beermats requires substantial creative effort and the resulting designs are often beautiful. Some coasters are collectible items. Tegestology is the practice of collecting beermats or coasters, with practitioners known as tegestologists. Tegestologists are often faced with the difficult task of how to display their collections in a meaningful way.

### SUMMARY OF THE INVENTION

As specified in the Background Section, above, there is a need in the art to come up with new ways to allow people display collected beermats as well as incentivize the display of beermats.

Thus, in one embodiment, the present invention provides an ornament comprising a center disc, the center disc further comprising a plurality of notches and a central hole; a plurality of beverage coasters, the beverage coasters further comprising a score line and a central rectangular cutout portion; and wherein the plurality of beverage coasters are folded along the score line and engaged with the center disc.

In another embodiment, a kit for the production of ornaments from coasters comprising a plurality of beverage coasters; a plurality of center discs, each center disc further comprising a plurality of notches, and a central hole; a means of communicating instructions for how to engage the coasters with the center discs so as to form ornaments.

In another embodiment a beverage coaster adapted for conversion into an ornament comprising a substantially flat article adapted for use as a surface on which to place a beverage and thereby protect an underlying surface on which the beverage coaster is placed, wherein the substantially flat article further comprises a score line to enable the substantially flat article to be folded cleanly along the score line; and a central rectangular cut out portion that enables the substantially flat article to be engaged by a center disc when the substantially flat article is folded along the score line.

In another embodiment a method for turning beverage coasters into an ornament comprising: selecting a plurality of beverage coasters; forming a score line in the plurality of beverage coasters; forming a central rectangular cutout portion; folding the plurality of beverage coasters along the score line; and engaging the beverage coasters that have been folded along the score line with a center disk.

### BRIEF DESCRIPTION OF THE DRAWINGS

FIG. 1 shows a decorative ornament formed from a plurality of coasters engaged with a center disc.

FIG. 1a shows a center disc further comprising an attachment means.

FIG. 2 shows the elements that make up a decorative ornament formed from a plurality of coasters.

FIG. 3 shows the process of folding the coaster along a score line to prepare them to form the decorative ornament and engaging the coasters with the center disc to form the ornament.

FIG. 4 shows the process of engaging folded circular coasters with the center disc to form the decorative ornament.

FIG. 5 shows the process of engaging folded square coasters with the center disc to form the decorative ornament.

FIG. 6 shows the process of scoring a line and creating a rectangular cutout in order to facilitate integration into a decorative ornament.

FIG. 7 shows a coaster adapted to be integrated into a decorative ornament.

### DETAILED DESCRIPTION OF THE INVENTION

Generally speaking the invention of the present disclosure comprises the following elements either alone or in various combinations:

Coasters: The coasters used may be any coasters known to those having skill in the art. In particular the type of coaster known as “beermats” are well suited. As described in the background section, beermats are items on which beverages are placed in order to protect the surface of a table or any other surface on which a beverage might be placed. Beermats are often branded with trademarks, and other advertising messages. Beverage coasters are often made from high grammage paperboard, but may also be made from multiple layers of thinner paper, such as tissue paper. Important considerations in the selection of materials for the construction of coasters are water absorbency, wet rub and printability characteristics. While the description of the embodiments of the invention focuses on beer mats/coasters, it will be apparent to those skilled in the art that other materials may be utilized to form the ornaments: namely posterboard, plastic, wood, metal and the like. It should also be noted that any shaped item may be used to form the decorative ornament.

Center Disc(s): The center discs provide the central structure about which the decorative ornaments are formed. The center discs may be made from any suitable material known to those having skill in the art including, plastics, paperboard, metal, and the like. The center discs further comprise a plurality of notches (N), in a preferred embodiment there are 8 notches. In some embodiments the center discs further comprise a central hole (N). In some embodiments the center discs further comprise a means for attaching the ornament to a Christmas tree or other suitable substrate. For example, in an embodiment the attachment means is a loop of flexible material, such as monofilament (N) that is attached to the center disc via insertion through the hole in the center disc and kept in place with a back plate (N).

Preparation Tool: The preparation tool is a tool specially designed to form a score line and a central rectangular cutout in a suitable beverage coaster/beermat. Generally speaking the functional elements of the tool are 2 straight blades (N) arranged in-line and separated by a rectangular cutout element (N). The rectangular cutout element (N) is a sharpened blade arranged to form a rectangle of corresponding size to the desired size of the rectangular cutout in the coaster. In some embodiments the tool may further comprise a coaster engagement member (N). The coaster engagement member (N) is a perimeter structure adapted to fit around the coaster to guide the placement of the score line and the rectangular cutout. Shown herein are coaster engagement members with a circular and square profiles adapted to fit the two most common shapes of coasters/beermats.

Instructions: In various embodiments, a means of communicating instructions on how to assemble coasters into decorative ornaments is provided. In some embodiments the instructions may further comprise information on how to prepare coasters that have not been pre-scored and cut, either using the provided tool or standard equipment. The means of communicating instructions may comprise an instruction sheet detailing the steps necessary to prepare coasters for use, and/or instructions on how to engage coasters with the center disc. In some embodiments the means for communicating instructions comprises a link to a website wherein the website contains instructions for use.

Turning now to the figures:

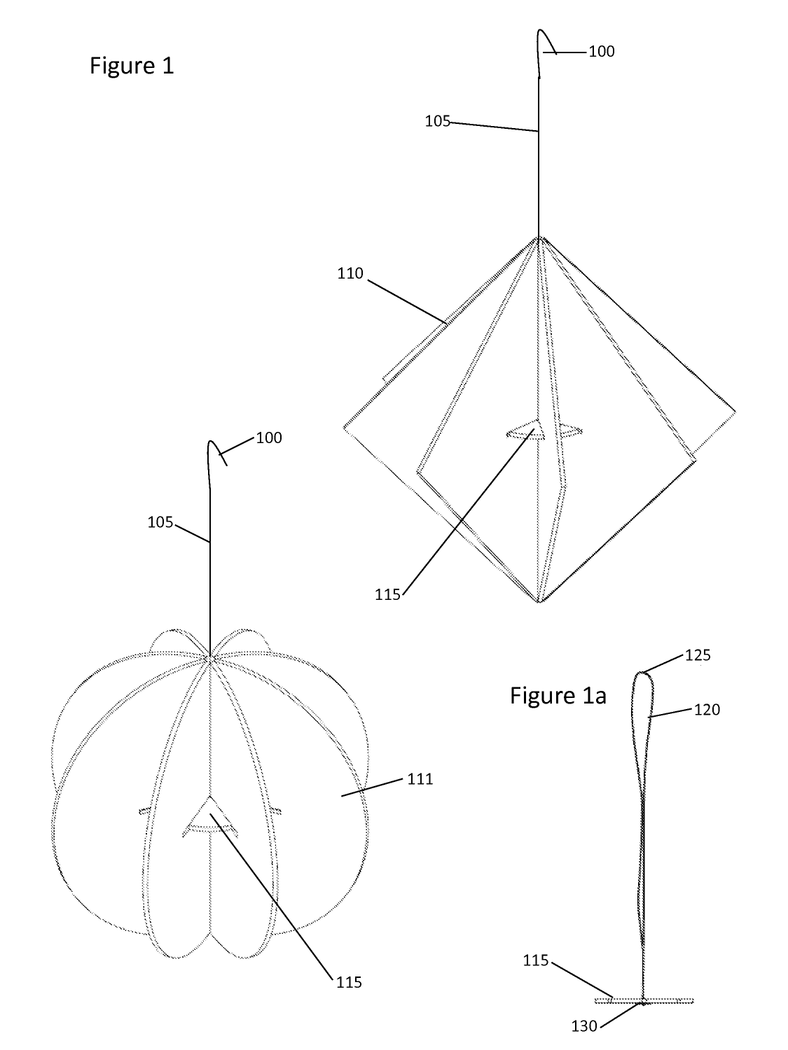

FIG. 1 shows embodiments of decorative ornaments of the present invention. The ornaments are constructed from a plurality of coasters (beermats) (110, 111) that have been folded along a score line (not shown) and engaged with a center disc (115) by engaging a rectangular cutout on the coaster (not shown) with the center disc. The coasters used for the creation of decorative ornaments may be square (110), round (111) or any other shape in which coasters are provided or created.

FIG. 1a shows an embodiment of the center disc wherein the center disc (115) further comprises an attachment means for attaching the ornament to a Christmas tree or other suitable display structure. In this example the attachment means is a loop (120) of flexible material, such as monofilament (125) that is attached to the center disc via insertion through the hole in the center disc and kept in place with a back plate (130).

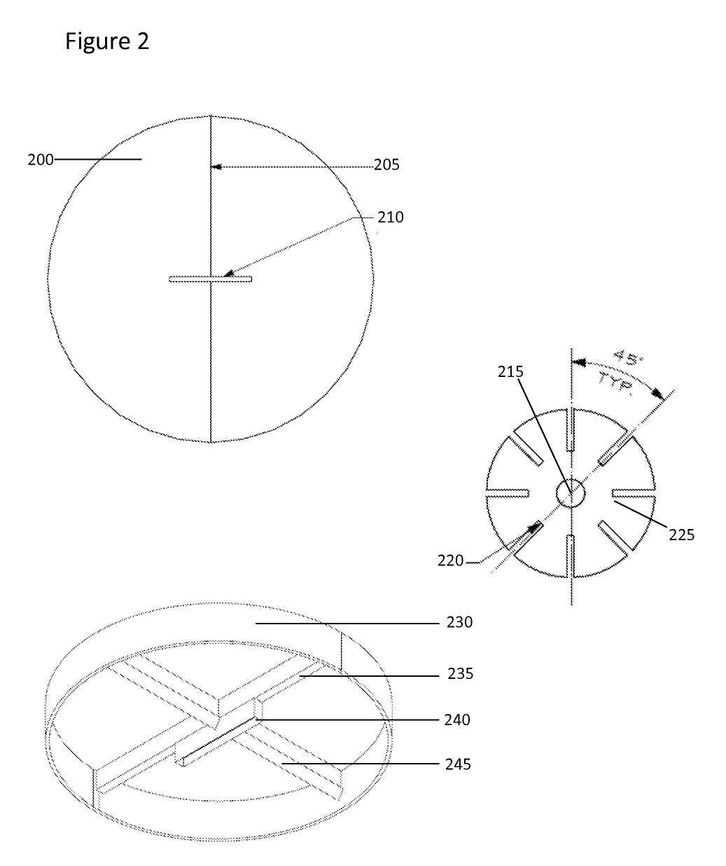

FIG. 2 shows an embodiment of the invention of the present disclosure wherein a kit for the creation of decorative ornaments is provided. In an embodiment, the kit comprises at least one but preferably a plurality of beverage coasters (200), at least one but preferably a plurality of center discs (225), each center disc further comprising a plurality of notches (220) and a central hole (215), and a means of communicating instructions for how to engage the coasters with the center discs so as to form the ornaments. In another embodiment the kit comprises at least one but preferably a plurality of center discs (225), each center disc further comprising a plurality of notches (220) and a central hole (215), a tool (230) to create a score line and a central rectangular cutout portion in a beverage coaster, and a means of communicating instructions for how to use the tool and how to engage the coasters, that have been modified by the tool with the center disc. In an embodiment the tool (230) comprises a scoring blade (245) a rectangular cutout blade (240) and a support member (235).

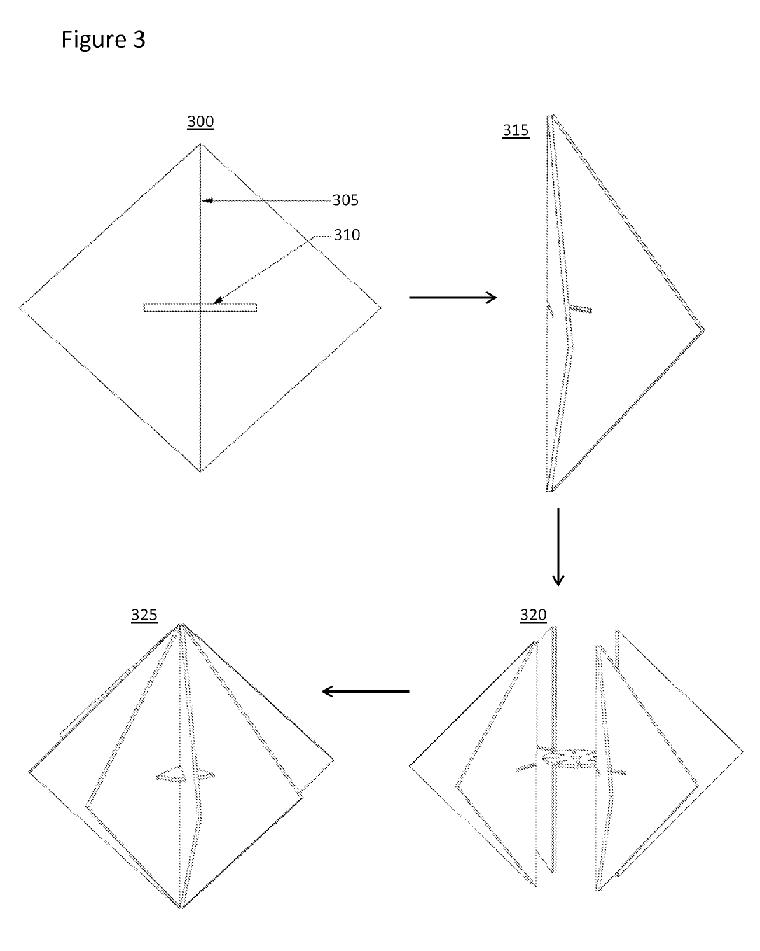

FIG. 3 shows the process of folding the coaster (300) along a score line (305) to prepare them to form the decorative ornament and engaging the coasters with the center disc to form the ornament. The process starts with a plurality of coasters. The coasters may be standard coasters/beermats, coasters/beermats that have been designed for conversion into ornaments, or any other substantially flat item that can be scored and engaged with the center disc. In the case where standard coasters are used, they will first have to prepped for conversion into ornaments. To do this, a score line (305) and central rectangular cutout (310) are made in the coaster. This can be done with the specialized tool (230, 630)) described in greater detail herein, and/or using standard equipment such as an exacto™ knife or the like. Next, the coasters are folded, approximately in half along the score line (315). Next, the folded coasters are engaged (320) with the center disc by fitting a notch of the center disc into the central rectangular cutout (310) of the coaster. The number of coasters engaged with a center disc to form an ornament can be variable. In a preferred embodiment, 4 coasters are added to each center disc.

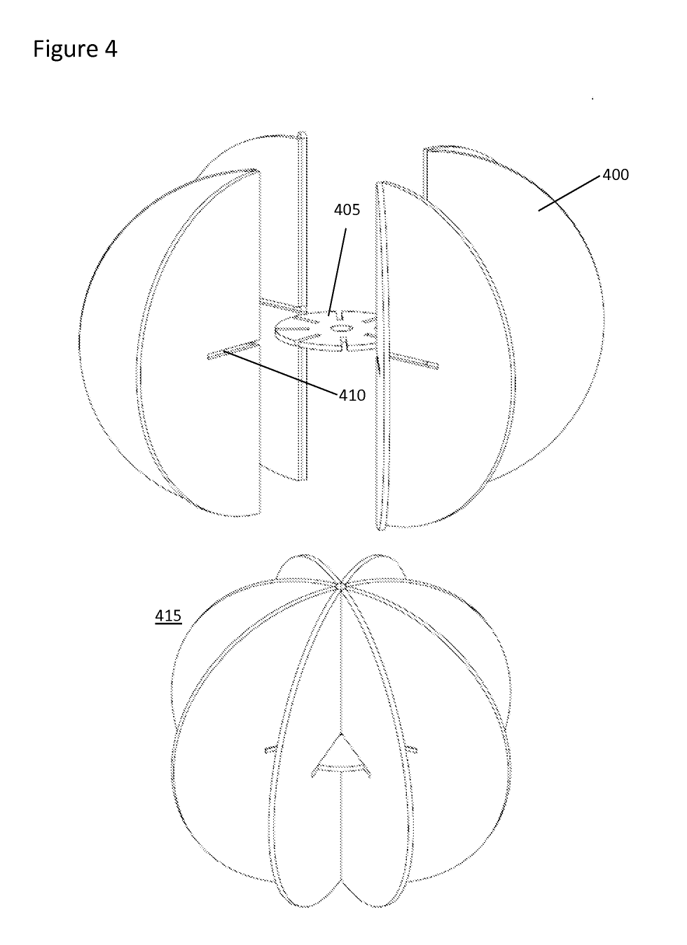

FIG. 4 shows the process of engaging folded circular coasters (400) with the center disc (405) to form the decorative ornament (415) by engaging the rectangular cutout portion (410) with the center disc.

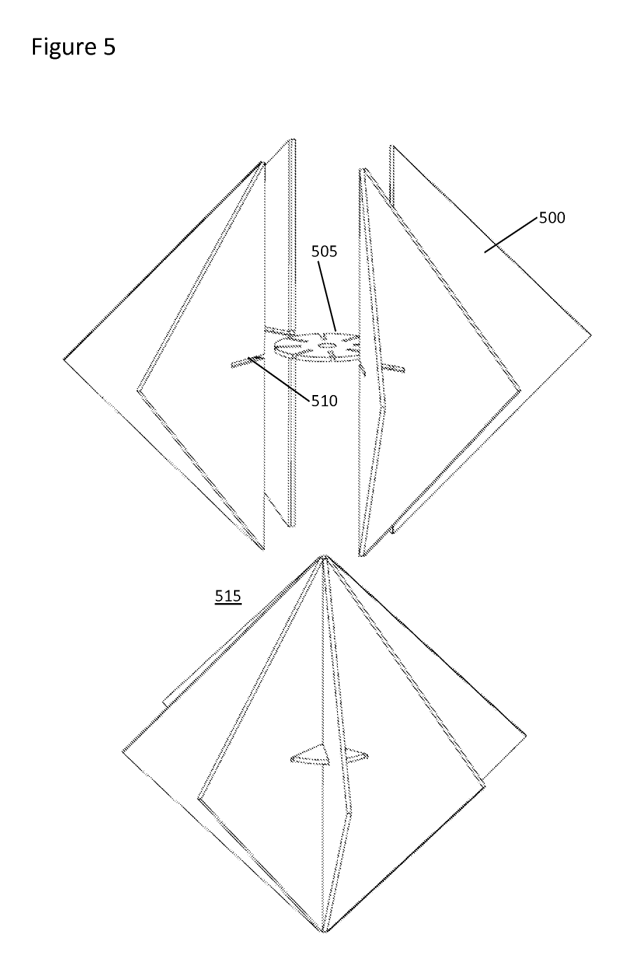

FIG. 5 shows the process of engaging folded square coasters (500) with the center disc (505) to form the decorative ornament (515) by engaging the rectangular cutout portion (510) with the center disc.

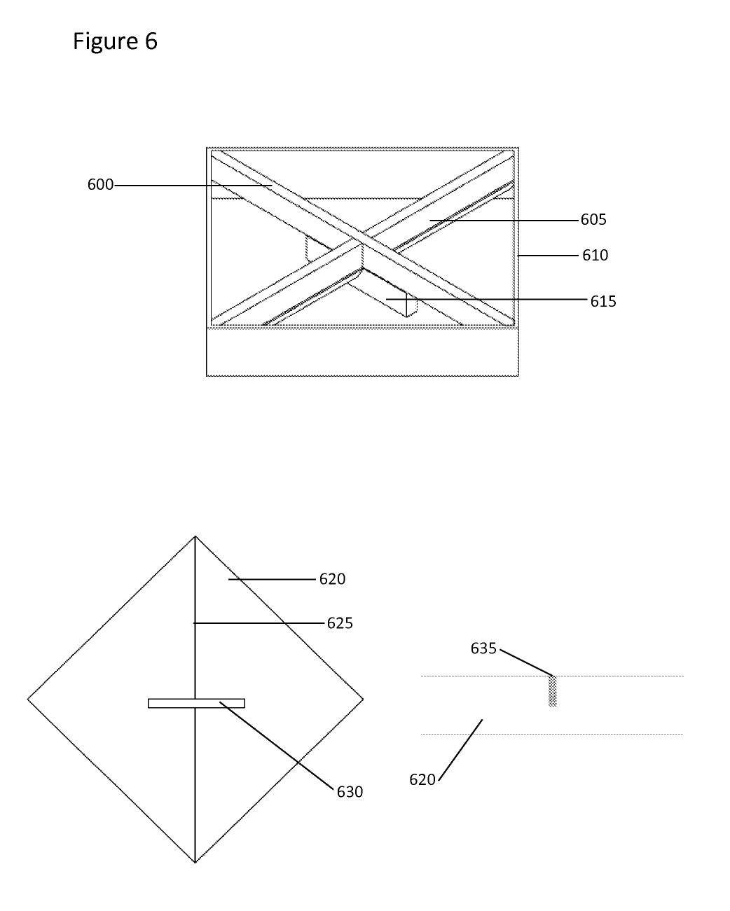

FIG. 6 illustrates the process of prepping a coaster/beermat for integration into a decorative ornament using a specialized tool (600) provided for that purpose. To prepare the coaster, the tool is pressed into the coaster. When pressed into the coaster the scoring blade (605) forms a score line (625) in the coaster (620) to prepare it for being folded, and the central rectangular cutout blade (615) forms the central rectangular cutout (630) for engaging the coasters with the center disc. The score line should penetrate 25-75% through the width of the coaster (635) to facilitate folding but not so far that the score line risks cutting the coaster (620) into two separate pieces.

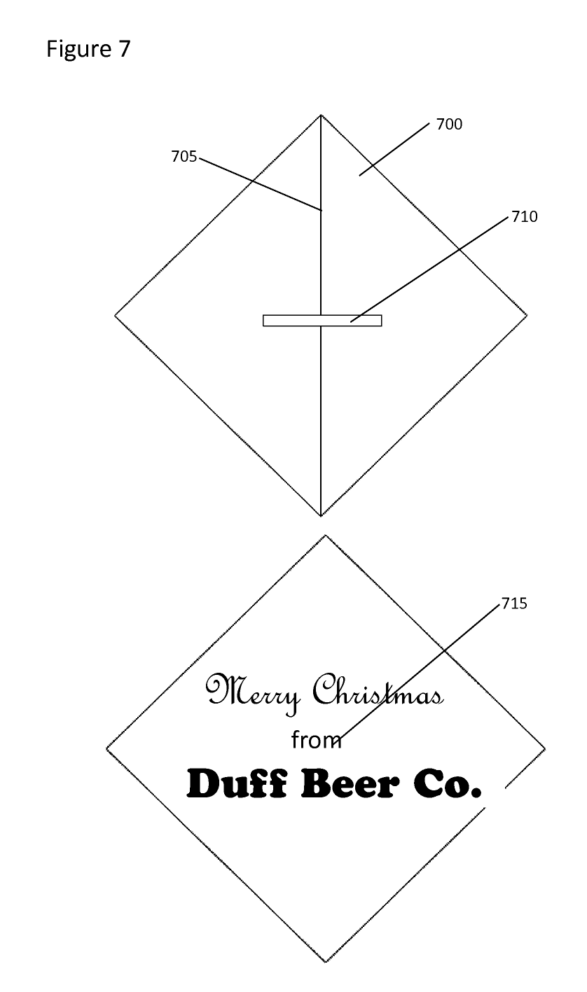

FIG. 7 shows a coaster (700) adapted to be integrated into a decorative ornament comprising a substantially flat article adapted for use as a surface on which to place a beverage and thereby protect an underlying surface on which the beverage coaster is placed, wherein the substantially flat article further comprises a score line (705) to enable the substantially flat article to be folded cleanly along the score line; and a central rectangular cut out portion (710) that enables the substantially flat article to be engaged by a center disc when the substantially flat article is folded along the score line. In some embodiments the coasters adapted to be integrated into a decorative ornament are printed with advertising language (715), images and/or slogans. In specific embodiments, the coasters are printed with seasonal holiday greetings. Coasters printed with seasonal holiday greetings may be particularly useful in advertising campaigns initiated by beverage companies during the Christmas season.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein, including all patents, published patent applications, and published scientific articles, are incorporated by reference in their entireties for all purposes.

1. An ornament comprising:
a center disc, the center disc further comprising a plurality of notches and a central hole;
a plurality of beverage coasters, the beverage coasters further comprising a score line and a central rectangular cutout portion; and
wherein the plurality of beverage coasters are folded along the score line and engaged with the center disc.

2. The ornament of claim 1 wherein the number of notches in the center disc is 6.

3. The ornament of claim 1 wherein the number of notches in the center disc is 8.

4. The ornament of claim 1 wherein the number of notches in the center disc is 10.

5. A kit for the production of ornaments from coasters comprising:
a plurality of beverage coasters;
a plurality of center discs, each center disc further comprising a plurality of notches, and a central hole;
a means of communicating instructions for how to engage the coasters with the center discs so as to form ornaments.

6. The kit of claim 5 wherein the plurality of coasters is adapted for engagement with the center discs by further comprising a score line and a central rectangular cutout portion.

7. The kit of claim 5 further comprising a tool to form a score line and a central rectangular cutout portion in the plurality of beverage coasters.

8. A beverage coaster adapted for conversion into an ornament comprising:
a substantially flat article adapted for use as a surface on which to place a beverage and thereby protect an underlying surface on which the beverage coaster is placed, wherein the substantially flat article further comprises a score line to enable the substantially flat article to be folded cleanly along the score line; and a central rectangular cut out portion that enables the substantially flat article to be engaged by a center disc when the substantially flat article is folded along the score line.

9. (canceled)
